(19) United States
(12) Patent Application Publication
(10) Pub. No.: US 2022/0335441 A1
(43) Pub. Date: Oct. 20, 2022

(54) Curbon's Climate Offset System

(71) Applicant: Joe Angelo Wahba, Dubai (AE)

(72) Inventor: Joe Angelo Wahba, Dubai (AE)

(21) Appl. No.: 17/722,581

(22) Filed: Apr. 18, 2022

Related U.S. Application Data
(60) Provisional application No. 63/175,951, filed on Apr. 16, 2021.

(51) Int. Cl. G06Q 30/00; G06Q 30/06

(52) U.S. Cl. CPC G06Q 30/018; G06Q 30/0641; G06Q 30/0627

(57) ABSTRACT

The current invention describes a method and system for climate offset on an individual level. In a non-limiting exemplary embodiment, the system allows the user to interact with the system at the time of purchasing a textile item. By navigating the system's features, the user is able to achieve a carbon offset for his or her purchase with a level of control and awareness of the process.

### CROSS-REFERENCE TO RELATED APPLICATION

This application is a US non-provisional patent application, which claims priority to U.S. Provisional Patent Application No. 63/175,951, filed on 16 Apr. 2022 and entitled “Curbon's Climate Offset System”, the entirety of which is hereby incorporated by reference.

### FIELD OF THE INVENTION

This invention related to a climate offset and more specifically to a system and method for offsetting carbon emissions.

### BACKGROUND

A carbon offset is a reduction in emissions of carbon dioxide or other greenhouse gases made in order to compensate for emissions made elsewhere. Offsets are usually measured in tones of carbon dioxide-equivalent.

Different methods exist for addressing carbon offset. Such methods are limited to decreasing the environmental impact of consumer products by only decreasing the carbon emissions associated with the life-cycle of each product. Almost all consumer products impact the environment in several ways that are not accurately calculated by only realizing their carbon contribution. As a result, the old method of performing the new invention's function do not account for the total environmental impact, and fail to include all environmental aspects of a product's production and usage.

In addition to missing important environmental aspects of a products life cycle such as a product's: methane, halogen, and nitrous oxide pollution, water usage, arable land depletion, chemical usage, physical pollution caused by a product's disposal and maintenance, and chemical usage, the existing method's rarely assess the environmental impact of individual consumer products. Currently, the majority of climate offset purchases are purchased per-ton of CO2. As a result, it's difficult to lessen the environmental impact of popular consumer products, such as garments, groceries, and electronics.

There is a desire in the field of a better and more accurate system and method for climate offset that addresses the abovementioned deficiencies.

### SUMMARY OF THE INVENTION

In view of the foregoing disadvantages inherent in the known types of environmental analysis systems now present in the prior art, the present invention provides a useful, novel, and unobvious invention for an automated system which evaluates the complete environmental impact of individual consumer products wherein the same can be utilized for displaying critical environmental information of consumer products to consumers and users of the system.

The general purpose of the present invention, which will be described subsequently in greater detail, is to provide a standardized means of analysing and communicating environmental information necessary for consumers to make informed decisions on their purchases. In addition, the invention intends to provide a means for consumers to offset this calculated impact by investing a monetary amount generated by the system's financial model into various third party environmental projects. The system's functions hold the advantages of environmental analysis systems mentioned heretofore and many novel features and functions that result in a new platform which is not anticipated, rendered obvious, suggested, or even implied by any of the prior art environmental analysis systems, either alone or in any combination thereof.

To attain this, the present invention generally comprises a software that receives and appropriate environmental data of consumer products from the system's database. In an embodiment, the system then evaluates the magnitude of the environmental impact of each product by dividing products' environmental impact into detailed metrics including, but not limited to: the carbon emitted by the production, transportation, maintenance, storage, and disposal, in addition to the water usage, chemical usage, dye usage, fibre, fabric, and yarn type amongst other factors and comparing them to certain benchmarks. It then displays the information to consumers and users in an easily understandable user interface.

In another embodiment, the system evaluates the magnitude of the environmental impact of each product by taking relevant information from the product's supply chain, deducing the ways in which the product impacted the environment, then dividing/organizing the products' environmental impacts into the nine planetary boundaries identified by the Stockholm Resilience Center. These boundaries include climate change, biosphere integrity, land-system change, freshwater use, biochemical flows, ocean acidification, atmospheric aerosol loading, stratospheric ozone depletion, and novel entities.

The system will then evaluate how consumer products impact each of these ecological boundaries by intaking supply chain related data on how the product is produced. These data points include (but are not limited to): the carbon dioxide, methane, or other GHG emissions emitted by the production, transportation, maintenance, storage, and disposal, to chemicals used throughout the production process, dye usage, fibre, fabric, yarn type, the fertilizers used to grow the raw materials for the product, any non-renewable resources used to produce the product, the freshwater usage, dangerous water discharge, plastic microfiber release into water systems, the location of the production facility, the name of the production facility, the energy used to produce the product measured in megawatt hours, the specific production processes, the general materials used to produce the product, the particular ways in which the product are disposed of, amongst other factors.

The system's database will contain a variety of environmental projects categorized by their contribution to the nine planetary boundaries. Once the artificially intelligent software is given the relevant data about a product's environmental impact, it will then assign certain projects which need to be invested in in order to mitigate the product's specific environmental impact. The system will look at factors such as the geographical location of the product's production and the nature in which it impacted the environment in order to specifically identify which projects will be best suited to mitigating its ecological impact.

The foregoing exemplary embodiments allow for structuring the calculation of products' environmental impacts as categories described by the nine planetary boundaries, including language about artificial intelligence, outlining out specifically environmental projects will be assigned to specific products, new ‘data points’ (underlined) which can be used to aggregate a product's impact.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims apprehended hereto.

In this respect, before explaining at least one embodiment of the invention in detail, it is to be understood that the invention is not limited in its application to the details of creating a software that displays individual consumer products' environmental information to users of the system. The invention is capable of other embodiments and of being practiced and carried out in various ways. Also it is to be understood that the phraseology and terminology employed herein are for the purpose of the description and should not be regarded as limiting.

A primary object of the present invention is to provide an environmental analysis system that evaluates the ecological impact of individual consumer products. A second object is to provide an environmental analysis system that allows buyers of consumer goods to reverse and offset the negative ecological effects that the life cycle of their products has had on the environment by investing a monetary amount, generated by the system, into various carbon positive, water restoration, and chemical waste cleanup projects.

An additional object is to link and suggest the purchase of different products on the database by comparing the similarity of their environmental impact amongst other factors. A further object is to track the environmental impact of the system's users' purchases and display to them their past purchases.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings illustrate non-limiting example embodiments of the invention.

FIG. 1 describes a logic flow of the method according to an exemplary embodiment of the current invention.

FIGS. 2-13 show images depicting the use of an interface of an exemplary system according to a non-limiting embodiment of the invention.

FIG. 14 shows image of an outline of the components and categories included in a database, from which Curbon may receive its environmental information, according to a non-limiting exemplary embodiment of the invention.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

### 1. General Purpose of the Invention

The invention's purpose is to offer its users the ability to lessen the environmental impact of their purchases. An example of such would be decreasing the environmental impact of clothing products. Every garment impacts the environment in a wide variety of forms as the result of its life-cycle as a consumer product. These impacts can include (but are not limited to): emitting high levels of greenhouse gas emissions, using large amounts of water particularly in water-scarce areas, releasing plastic microfibers into the ocean trough washing and drying, occupying large areas of arable land, relying on the use of nonrenewable resources that require large amounts of oil to produce, and using harmful chemical and pesticides to grow cotton. At the point of purchase, the invention will allow its user to lessen these environmental impacts by investing a product-specific monetary value into various environmental projects around the globe that work to help mitigate the various environmental damages of consumer goods. Carbon positive projects, water restoration projects, ocean cleanup initiatives, chemical reduction projects, amongst other environmental projects are all examples of projects that the invention uses to decrease its users' environmental footprint.

A secondary purpose of the invention or system is to offer producers of consumer goods the ability to mitigate the complete environmental impact of their purchases before their products are sold. After production—(but before releasing/selling the product to the public—a company can provide the artificially intelligent software with relevant information about the products' specific supply chain. The system will then intake this data and quantify the product's environmental impact into nine categories. Finally, the system will produce a singular monetary cost in which the producer can pay in order to help mitigate the various environmental damages of their consumer goods. This cost is calculated by aggregating independent investments various environmental projects globally which work to mitigate the nine planetary boundaries of climate change as defined by the Stockholm Resilience Center.

The system can either mitigate the environmental impact of singular consumer products or a cohort of similar products. The system would mitigate the impact of a cohort of products by averaging the variety and scale of the group of products' environmental impacts and finding suitable investment opportunities which best suit the products' mitigation needs.

The above allows for a business to business scope of operation, introducing the idea that the monetary cost is a product of working to mitigate the SRC's nine planetary boundaries, and realizing that the software can mitigate the damages of either individual products or a cohort of products.

### 2. Method

Currently, there are two methods of performing the function of the new invention. If a consumer wishes to lessen the environmental impact of a purchase, they can invest into a carbon positive project, of which there are thousands available to openly invest in. These projects include wind power, forest regeneration, solar power, biogas, hydroelectric, biomass, geothermal, and cookstove projects to “offset” the carbon cost of their purchases.

### 3. Technical Description of the Invention and the “Offset Now” Feature

The present invention provides a method and system for a multivariate climate offset in a client/server environment. In one embodiment, the system comprises an interface for inputting data. Such data may be retrieved for example for one or more sources or it may be entered manually by a user through the interface. The system also includes a general processor, and a memory that is either integral or external to the processor, collectively referenced as a server system, that is in data communication with the interface. Once data is received by the processor, the server system assigns a unique client identifier to each client system. The purchaser-specific order information may have been collected from a previous order placed by the purchaser. The server system maps each client identifier to a purchaser that may use that client system to order an offset. When a purchaser wants to order an offset, the purchaser uses a client system to send the request for information describing the item for which the offset is to be ordered. The server system determines whether the client identifier for that client system is mapped to a purchaser. The server system sends the requested information to the client computer system. When the purchaser performs the offset action, the client system notifies the server system. The server system then sends back a list of environmental projects corresponding to each category (e.g., carbon/water/chemical) to the client system. In one embodiment, each project has a unique project identifier and a cost per kilogram. The purchaser then selects a project from each category. Once the projects have been selected, a total cost is calculated by multiplying the cost per kilogram of each project with the mass of its climate aspect (eg. carbon/water/chemical) and aggregated. The client system is requested to proceed to a payment portal to pay the total cost of the climate offset. Once the payment has been initiated, the client system sends the unique identifier of the product along with the unique identifiers of each selected project to the server system.

TABLE 1
describes a sample of data that may be collected
as input for the above described system.

| | | | |
|---|---|---|---|
| Carbon | Water | Chemical | Other |

| | | |
|---|---|---|
| Material Composition | Material Composition | Reporting Period |
| | | (start and end date |
| | | of data collection) |
| Material Weight (g) | Material Weight (g) | |
| Waste Percentage (yes/no | Type of Washing | |
| if waste is recycled) | | |
| Country/Region of | Frequency of Washing | |
| Manufacturing | | |
| Assembly Steps | Type of Drying | |
| Electricity Per Process | Frequency of Drying | |
| (kWh/kg) | | |
| Fuels Per Process | Water Intensity of | |
| -Nat. gas (cut.FT/kg) | Raw Material (growing) | |
| -Diesel(liters/kg) | (gallons/kg) | |
| Distance of Transport of | Total Water Use of | |
| Raw Materials to | Product (gallons/kg) | |
| Assembly + Weight | | |
| Distance of Transport of | Total Water Discharged | |
| Assembly to | (gallons/kg) | |
| Warehouse + Weight | | |
| Distance of Transport | Total Water Treated | |
| Between Warehouses | On-Site (gallons/kg) | |
| and Stores + Weight | | |
| Customer Distribution | Total Amount of water | |
| Travel + Weight | Returned to Source | |
| | (gallons/kg) | |
| Weight of Packaging | Water Source | |
| Material + Weight | | |
| Packaging Material | Water Intensity of | |
| Composition | Wash Cycle (gallons/cycle) | |
| Type of Washing | Waste Water (gallons/kg) | |
| Frequency of Washing | | |
| Type of Drying | | |
| Frequency of Drying | | |
| Landfill Incineration | | |
| Carbon Intensity | | |
| (kg C02/kg material) | | |
| Carbon Intensity of Raw | | |
| Materials (kg C02/kg) | | |
| Carbon Intensity of | | |
| Material Processing Steps | | |
| Electricity Grid Emissions | | |
| (kg C02/kWh) by | | |
| country/region | | |
| Carbon intensity of | | |
| transportation mode | | |
| (kg C02/tonne or km) | | |
| Wash Cycle Energy | | |
| Intensity (kWh/kg load) | | |
| Dry Cycle Energy Intensity | | |
| (kWh/kg load) | | |
| Percentage Landfill vs | | |
| Percentage Incineration | | |
| Landfill Carbon Intensity | | |
| (kg C02/kg) | | |
| Incineration Carbon | | |
| Intensity (kg C02/kg) | | |

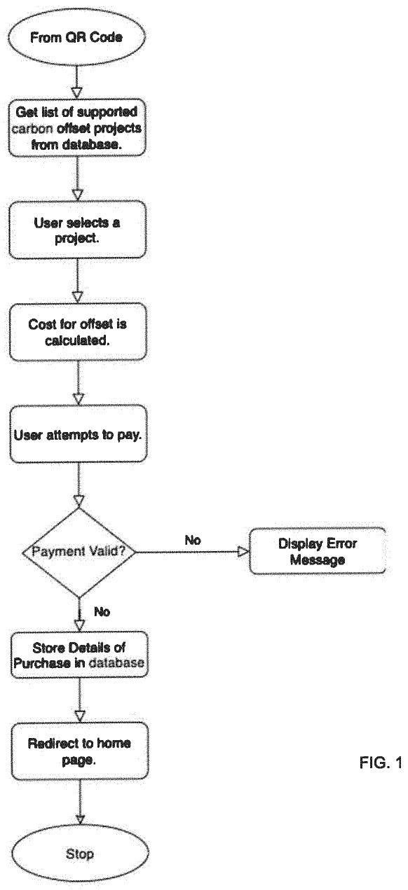

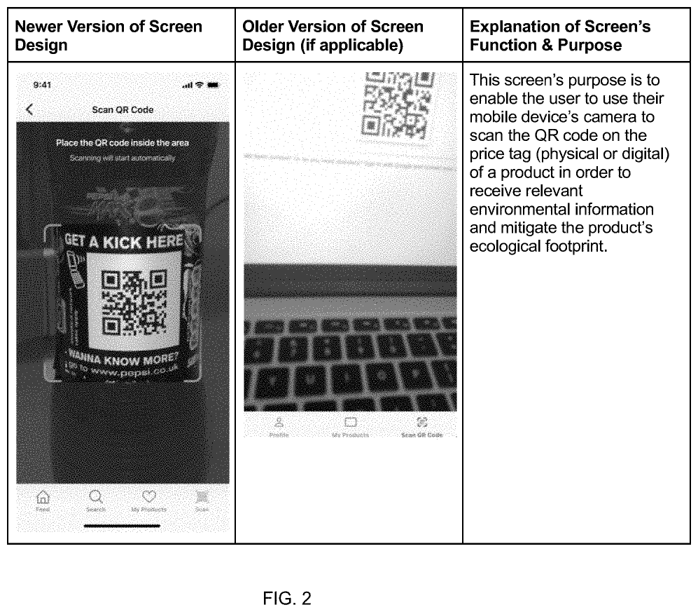

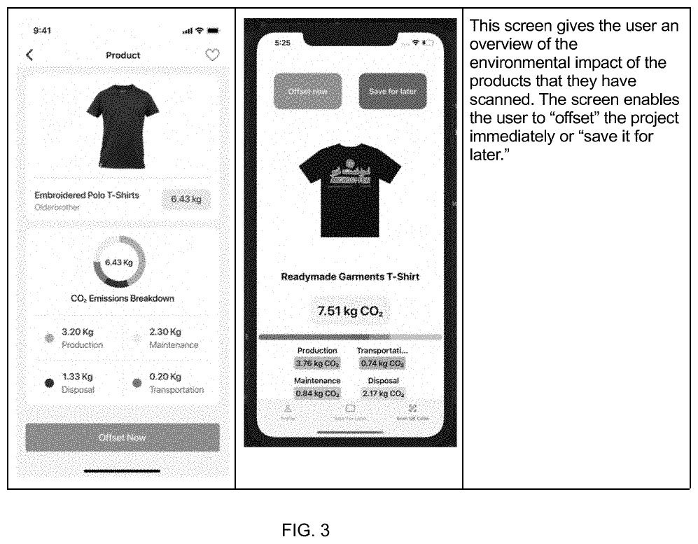

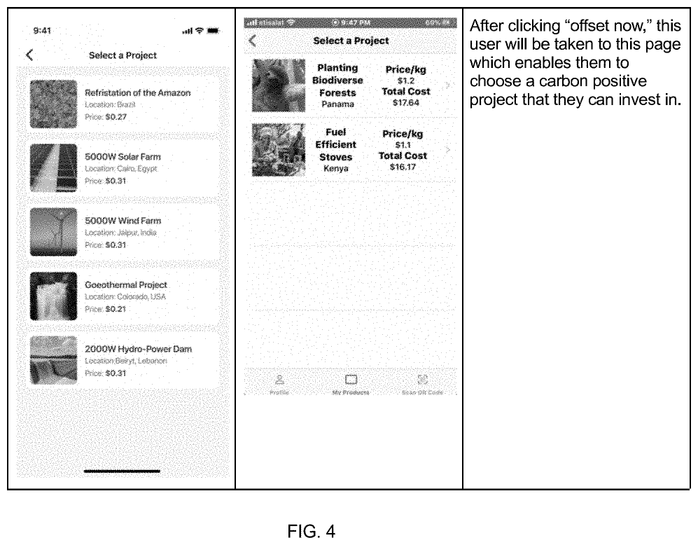

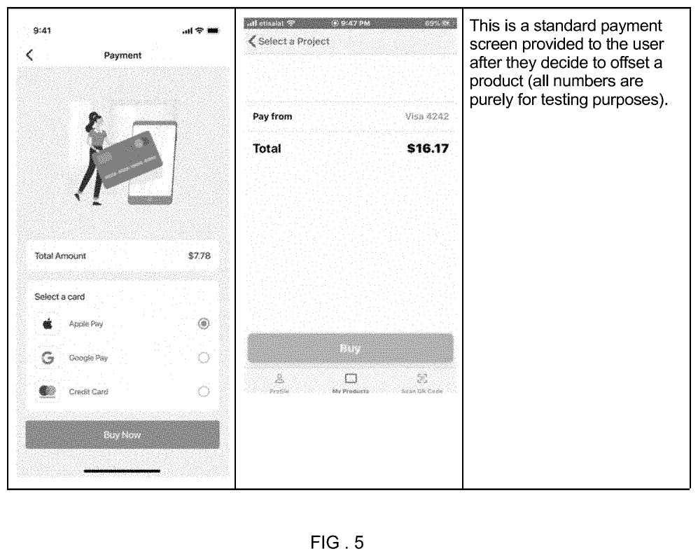

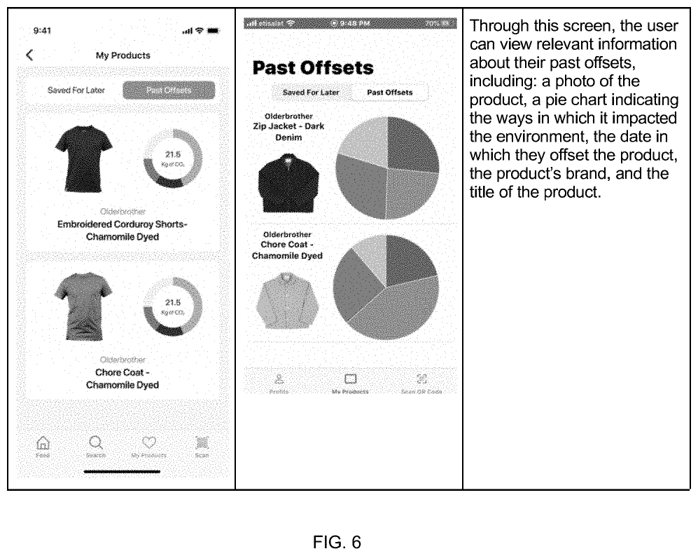

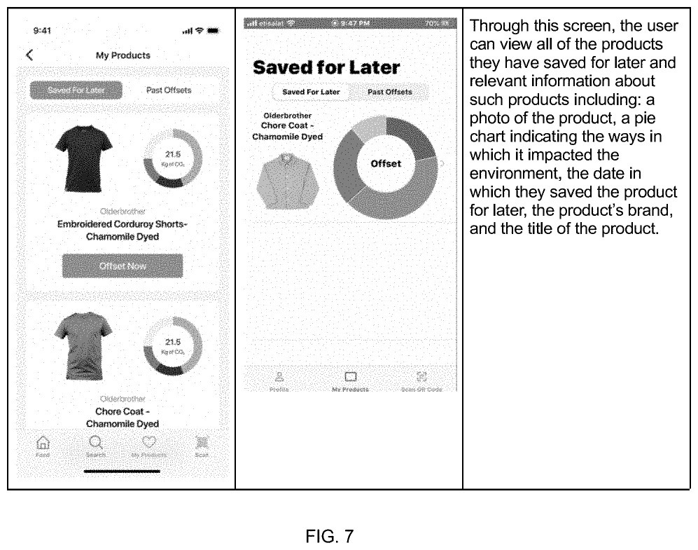

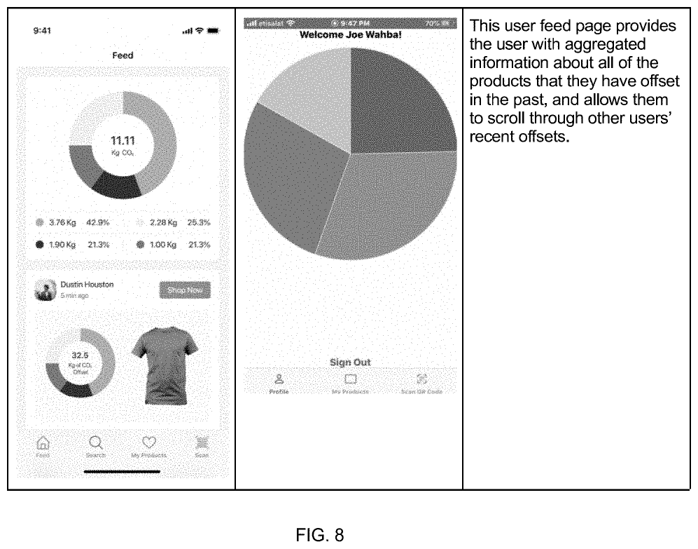

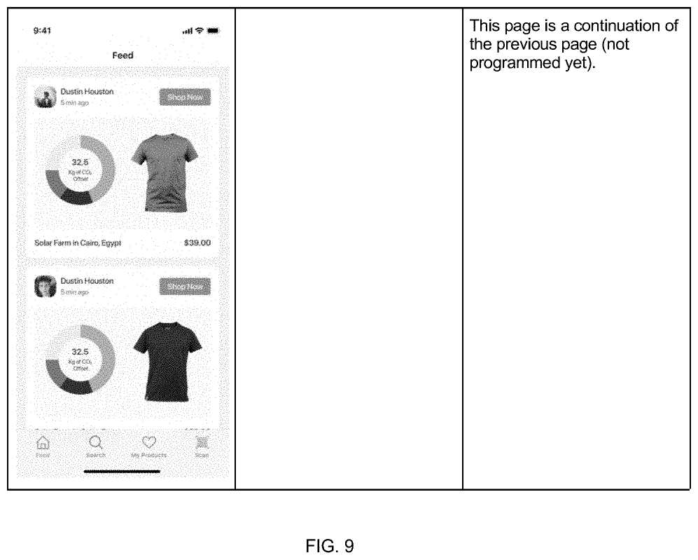

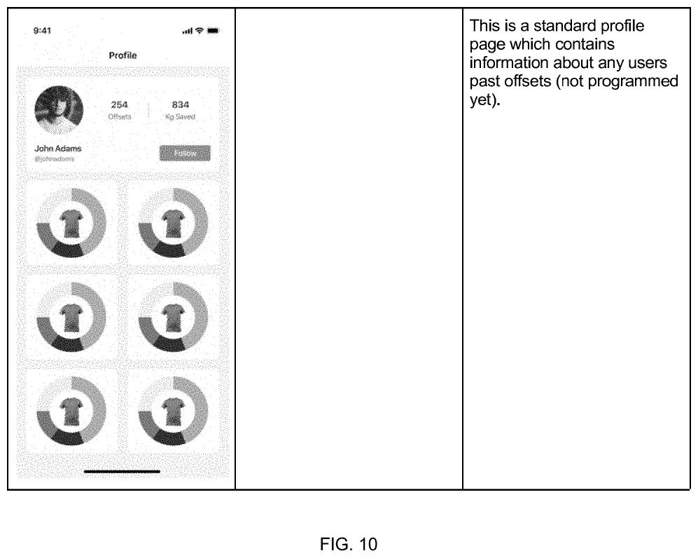

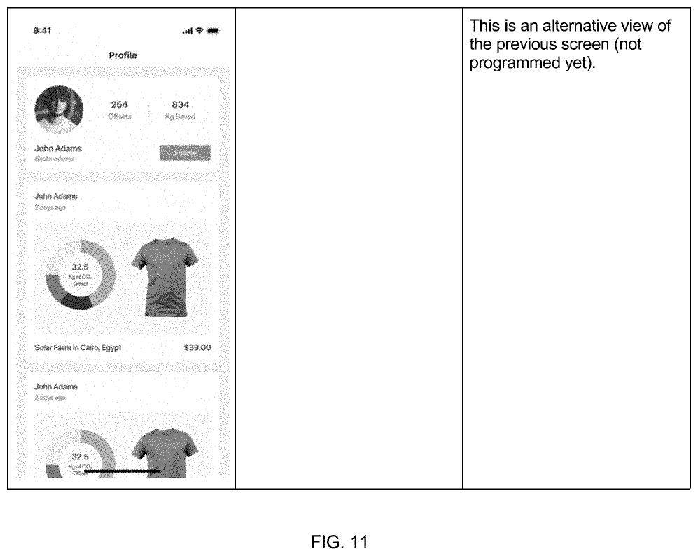

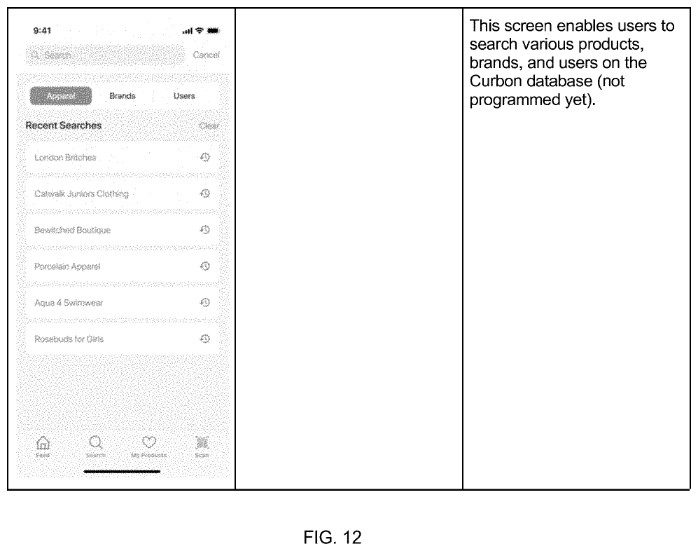

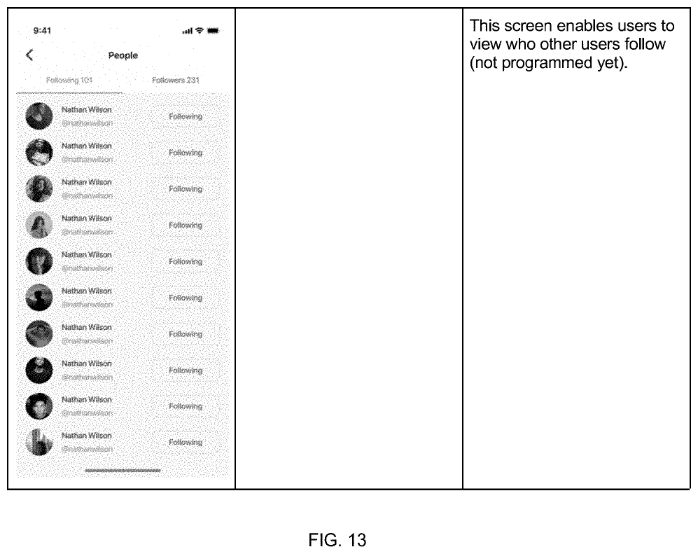

FIG. 1 describes the logic flow of the method of the current invention according to an exemplary embodiment. FIGS. 2-13 provide images depicting the use of an interface of a non-limiting exemplary embodiment of the invention. FIGS. 2-13 specifically provide the sequential steps a user may go through in using the system to achieve climate offset for the user's purchase. It is to be noted that some of the steps disclosed may be optional, is not to be considered essential to the working of the method and may be removed in alternative embodiment contemplated under the current invention.

The system may have a database that allows for retrieving information by the processor for demonstration to the user. An exemplary data model may be presented as follows:

### Data Model:

Product
   Name
   Image
   Climate data
Manufacturer
   Name
   Product by manufacturer
User
   Username
   Name
   Email
   Password
Project
   Name
   Location
   Image
   Price per KG
Purchase
   User
   Product
   Project
   timestamp

In a non-limiting exemplary embodiment, the parent view of the interface contains a tab bar with 3 tabs: QR Code Offset, Profile Info, View Saved for Later and Past Offsets.

### Data Processing:

### Calculating Carbon Footprint by Life-Cycle Step

Materials (M1)=(Material weight+Waste weight)(kg)×(Material carbon intensity kg CO2/kg material)

Manufacturing (M2)=(Energy Used)(kWh/process)×(Electricity grid emissions)(kg CO2/kWh)

Transport (T)=(Distance)(km)×(Product weight)(kg)×(Transportation mode carbonintensity)(kg CO2/kg product per km)

Maintenance (M3)=((Number of wash cycles)(#)+Number of dry cycles(#))×(Product weight (kg))×(Wash/Dry carbon intensities)

Disposal (D)=(Material weight)(kg)+(Landfil/Incineration carbon intensity)(kg CO2/kg material)

M1+M2+T+M3+D=Total life-cycle emissions (kg CO2)

### Calculating Water Footprint by Life Cycle Step

Materials (M1)=(Material weight+Waste weight)(kg)×(Material Water Intensity gallons/kg of material)

Manufacturing (M2)=(Total Water Discharged)(gallons)+(Total Water Treated)(gallons)−(Total Water Returned to Source)

Maintenance (M3)=(Number of Wash Cycles)(#)×(Water Intensity of Wash Cycle)(gallons/ cycle).

In operation, the method exercised by the exemplary system embodiment described above may be have the following steps:

### Step 1—Scan QR Code:

The user clicks on the QR code offset button and the child view changes to a QR code scanner using the camera. The QR Code scanner view is used from a library.
The QR code represents a unique key that links to a product on our database.
The QR code unique key is used to fetch data from a document on Firebase. This data is then cleaned and used to create a Product object.
The Product object is then passed into a view which displays the climate footprint of the product in the form of a bar chart, along with buttons to ‘Offset Now’ and ‘Save for Later’.

### Step 2—Project Selection:

The user clicks on ‘Offset Now’
The app fetches a list of projects from our database with information such as an image, name, location and price/kg.
The app calculates the cost of this particular climate offset and displays it along with the project data.

### Step 3—Payment:

The user proceeds to pay.
They can then enter their credit card information for payment or pay using Apple Pay if they have it setup.

### Step 4—Completing the Offset:

Once the payment has been authenticated, the cost of the climate offset is automatically routed to the selected project.

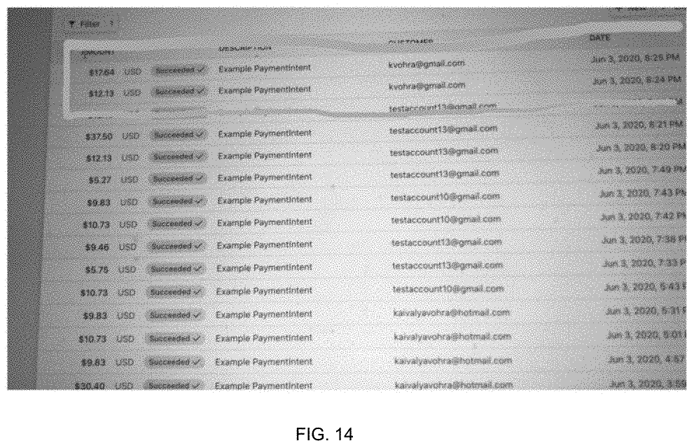

FIG. 14 shows an outline of the components and categories included in a database, from which Curbon may receive its environmental information, according to a non-limiting exemplary embodiment of the invention. The database depicted in FIG. 14 is powered by Google FIrebase. It is to be understood that other platforms and software may be used to generate and maintain the database. FIG. 14 demonstrates successful “test” payments completed through Curbon's database using Stripe, an online payment processing business for internet businesses.

In another embodiment, in order to mitigate the environmental impact of consumer products, the system may provide users/producers an ‘offset cost’ feature. The offset may be done in different ways. Provided below are two non-limiting examples of offset options which will be defined as the following:

1: ‘Immediate Action’ Offset Now Feature: This offset focusses on immediate mitigation. The immediate action offset now feature will be one cost consisting of various investments into environmental projects globally that work in real-time to prevent or reduce environmental damage. These environmental projects include:

### Carbon Positive Projects

Clean Energy Projects
   Solar
   Wind
   Geothermal
   Hydropower
   Biomass
Natural Restoration Projects
   Tree planting
   Conservation farming
   Ecological restoration
   Natural world preservation

### Regenerative Agriculture Projects

Organic farming
No-till farming
Restorative razing

### Water Restoration

Ecological water restoration
   Wetland restoration
Ocean cleanups

2: ‘Future Action’ Offset Now Feature: This offset focusses on long-term mitigation/innovation. The future action offset now feature will be a cost consisting of various investments into environmental research projects that are aimed at finding more efficient and effective ways to combine resources with the goal of preventing future environmental damage or working to reverse certain environmental damages. These environmental projects include investment into any one or combination of: carbon capture technologies, green hydrogen innovation and production, methane capture, research focused on measuring environmental damages, research and development into new environmentally sustainable materials, high-tech solutions preventing and mitigating environmental damage, microfiber capture technology, and sustainable waste management solutions.

In the exemplary embodiment provided above, the offset now feature is split into two products, specifically, one that focuses on immediate mitigation and one that focuses on log-term solutions for environmental impact mitigation.

The current invention allows consumers to easily lessen the environmental impact of their individual purchases by reducing the amount of research required to do so. Currently, if a consumer or company would like to lessen the environmental impact of singular products, it is likely that they must consult a carbon offset company/consultant to research the product and return with a quotation of sorts. The new invention allows consumers to complete a climate offset at the point of purchase within seconds which will definitely increase the probability that consumers will choose to decrease the impact of their purchases.

The current invention also completes climate offsets to a much higher degree of accuracy in comparison to what has been done before. This is due to the fact that the new invention collects a much wider range of environmental data than the current system. As stated before, currently climate offsets are only limited to investing funds into carbon positive projects.

The invention can be implemented into a system comprising an general processor for executing instructions compiled in an algorithm, which when executed by the processor would allow consumers to use the invention directly. The system would inform the users of their purchases' negative impact on the environment, then allow them to climate offset these products by investing into various environmental projects through an “offset now” button. Another example would include the invention's integration with e-commerce platforms, such as a climate-offset being an additional purchase at online checkouts.

The textile industry demonstrates the value of this invention. A 2020 survey of European consumers conducted by McKinsey & Company focused on consumer sentiment on sustainability in fashion revealed that two-thirds of their surveyed consumers believe that, post-crisis, it has become even more important to limit impacts of climate change. In addition, 88% of respondents belie that more attention should be paid to reducing pollution. The same survey revealed that more than half of the respondents have already made significant lifestyle and behavioral changes to lessen their environmental footprint. It's also evident that the new generation of consumers are willing to go the extra mile in order to consume consciously. According to a Nielsen survey conducted in 2015, 73% of Millennial consumers are “willing to pay extra for sustainable offerings,” a number that has increased from below 50% in 2014. The survey states that Generation Z's consumers are as willing to pay extra for sustainable products.

Amongst the largest fashion brands and retailers, “only 1% of new products introduced in the first half of this year (2019) were tagged sustainable” (Forbes). These brands understand the challenge and are willing to tackle the higher costs and lower availability of sustainable materials in order to transform their products. According to a 2017 McKinsey study, “more than half of the industry players want at least half of their products to be made with sustainable materials by 2025.” The study indicated that the combined spending power of these companies is well over $100 billion. This invention would definitely lessen the environmental impact of the textile industry, and provides a service demanded by not only consumers, but clothing retailers as well.

What is claimed is:

1. A method of climate offset according to the optional embodiments described in the specification.

2. A system for climate offset according to the optional system embodiments described in the specification.
